(19) United States
(12) Patent Application Publication
(10) Pub. No.: US 2015/0002433 A1
(43) Pub. Date: Jan. 1, 2015

(54) METHOD AND APPARATUS FOR PERFORMING A ZOOMING ACTION

(71) Applicants: David Karlsson, Lund (SE); Henrik Höjer, Sodra Sandby (SE)

(72) Inventors: David Karlsson, Lund (SE); Henrik Höjer, Sodra Sandby (SE)

(73) Assignee: SONY ERICSSON MOBILE COMMUNICATIONS AB, Lund (SE)

(21) Appl. No.: 14/356,548

(22) PCT Filed: Jan. 16, 2012
(86) PCT No.: PCT/EP2012/050579

§ 371 Date: Aug. 18, 2014

Related U.S. Application Data
(60) Provisional application No. 61/561,283, filed on Nov. 18, 2011.

(51) Int. Cl. G06F 3/041; G06F 3/0484; G06F 3/0488; G06F 3/0485

(52) U.S. Cl. CPC G06F 3/0416; G06F 3/0412; G06F 3/0485; G06F 3/04845; G06F 3/0488
USPC 345/173

(57) ABSTRACT

A method comprising identifying a touch point origin in response to a user touching a touch sensitive display device with a finger is provided. The display device displays a graphical image. The method comprises detecting a rotational movement of the finger relation to the origin, determining a rotational direction of the rotational movement and performing a zooming action associated with the rotational direction of the rotational movement.

### TECHNICAL FIELD

The present invention relates to a method comprising identifying a touch point origin in response to a user touching a touch sensitive display device with a finger. The display device displays a graphical image. The method further comprises detecting a rotational movement of the finger in relation to the origin, determining a rotational direction of the rotational movement and performing a zooming action associated with the rotational direction of the rotational movement.

### BACKGROUND

Touchscreen displays often provide a separate menu to select a zoom-in or a zoom-out action. The menu may have at least one selection button for zoom-in and at least one selection button for zoom-out. In one example, the touchscreen display device includes multiple keys, which are displayed on a touch surface. The keys provide input positions for user input, a touch sensor identifies touches to the display surface and identifies a corresponding action. Some touchscreen displays are able to interpret a wide range of inputs, wherein a gesture applied at any position on the display screen corresponds to an action. For example, a pinch zoom gesture with two fingers touching the screen implements a zoom in or zoom out action.

A problem with the pinch zoom gesture, two finger zoom, is that the pinch gesture forces the user to obscure much of the screen with the hand. The hand may be tilted to obscure the screen a bit less, but it will instead put the hand in an uncomfortable position. The user also need to change from normal touch input mode or panning mode where one finger is used, to pinch zoom mode using two fingers.

Another zooming function solution is to show a zoom bar, which can be operated with a single finger, which usually means that less of the user interface will be obscured by the hand, but when the screen size is limited it is desired to keep the user interface elements to a minimum, hence a zoom bar is usually not a good alternative. The normal touch input mode and panning mode, both using one finger, will be interrupted by moving the finger to a scroll bar.

In a cell phone, or other small screen device, the display and touch screen is adapted for a single touch selection, which users may find more convenient than two finger selection techniques. The ability to implement a zoom or other function using just one finger, stylus or touch apparatus enables a user to implement actions in a manner consistent with the size of the device.

US 2011029917A1 describes a touchscreen display device implementing a single touch operation using a spiral rotation gesture on a touchscreen display device to magnify the display of an image. Continued spiral rotations result in continued magnification. A zoom-in or zoom-out operation is implemented by a single touch spiral rotation. In one example, a spiral rotation defining an increasing area has a corresponding action to reduce a display portion of the display screen. Similarly, a spiral rotation defining a decreasing area has a corresponding action to magnify the display portion of the display screen. A floating origin may be used to identify gestures at various positions on a touchscreen display. A disadvantage with the known technique is that a relatively large movement is performed, thus being inconvenient when using a device with a small touch screen. Another disadvantage is that an ongoing panning mode will be interrupted to go into this kind of zoom gesture mode. It is not possible to perform panning and zooming actions in parallel.

### SUMMARY OF THE INVENTION

An object with the present invention is to provide a method that prevents at least parts of the drawbacks mentioned above. This object is obtained by providing a method comprising identifying a touch point origin in response to a user touching a touch sensitive display device with a finger. The display device displays a graphical image. The method further comprises detecting a rotational movement of the finger in relation to the origin, determining a rotational direction of the rotational movement and performing a zooming action associated with the rotational direction of the rotational movement.

Thus, a single finger zooming action is enabled by detecting the location of the finger on a touch screen, and then detecting a rotational movement of the finger. Zooming action may then be performed in a simple way using only one single finger.

According to embodiments may the rotational movement be performed while the tip of the finger is still in contact with the touch point origin. Thereby, the movement is minimized, and fast and easy zooming action may be performed while still only cover a part of the screen handled.

According to embodiments may the rotational movement be a clockwise rotation of the finger.

According to embodiments may the clockwise rotation be associated with a zooming in action.

According to embodiments may the rotational movement be a counterclockwise rotation of the finger.

According to embodiments may the counterclockwise rotation be associated with a zooming out action.

According to embodiments may the method further comprise performing a panning action of the graphical image on the display device in response to the user performing a sliding movement of the finger from the touch point origin to another touch point thereby determining direction and extent of the panning action.

According to embodiments may the panning action of the graphical image be performed in parallel with the zooming action.

In another aspect, an apparatus comprising means for identifying a touch point origin in response to a user touching a touch sensitive display device with a finger is provided.

The display device displays a graphical image. The device comprises means for detecting a rotational movement of the finger in relation to the origin, means for determining a rotational direction of the rotational movement and means for performing a zooming action associated with the rotational direction of the rotational movement.

According to embodiments may the means for identifying a touch point origin comprise a touch sensor comprised in the display.

According to embodiments may the means for detecting a rotational movement of the finger comprise a touch sensor comprised in the display.

According to embodiments may the means for detecting a rotational movement of the finger comprise at least one proximity sensor. The use of a proximity sensor improves touch interfaces by using the information about the hand orientation and movement to improve zooming action.

According to embodiments may the means for detecting a rotational movement of the finger comprise a plurality of proximity sensors.

Further features and advantages of the present invention emerge from the attached claims and the following detailed description. The skilled man within the area realizes that different features of the invention may be combined to create second embodiments other than the described below. This may be done without deviating from the scope of protection of the present invention defined by the attached claims.

### SHORT DESCRIPTION OF FIGURES

Different approaches to the invention, including specific features and advantages, are shown from the following detailed description and the accompanying figures, in which:

FIG. 1 shows a traditional two-finger zooming action.

FIG. 2 is a flow chart showing a method in accordance to one embodiment.

FIG. 3 shows a zooming action performed in accordance to embodiments.

FIG. 4 shows an image of a touch sensor signal detecting a finger tip with touch point origin information and directional information.

### DETAILED DESCRIPTION

The present invention will now be described more in detail with reference to the attached figures, in which examples of embodiments is shown. The invention shall not be interpreted to be limited to the examples described of embodiments. Like references in the figures refer to like elements. To simplify, well known functions and constructions will not necessarily be described in detail.

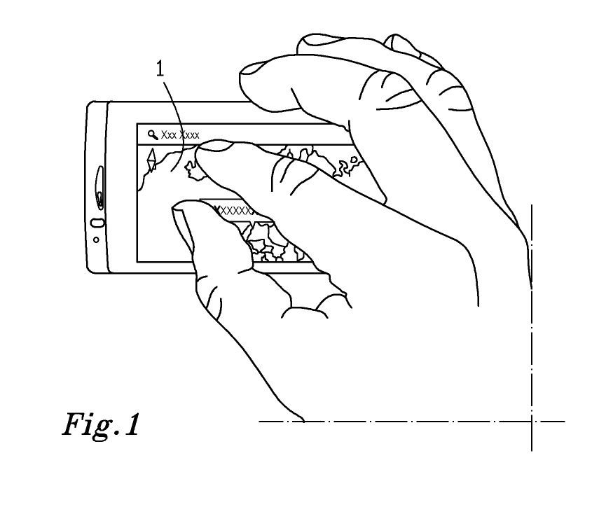

FIG. 1 shows a traditional way of zooming in and out using a typical two finger gesture. As can be seen from the figure, a large area of the display 1 will be blocked by the hand when such a zooming action is performed.

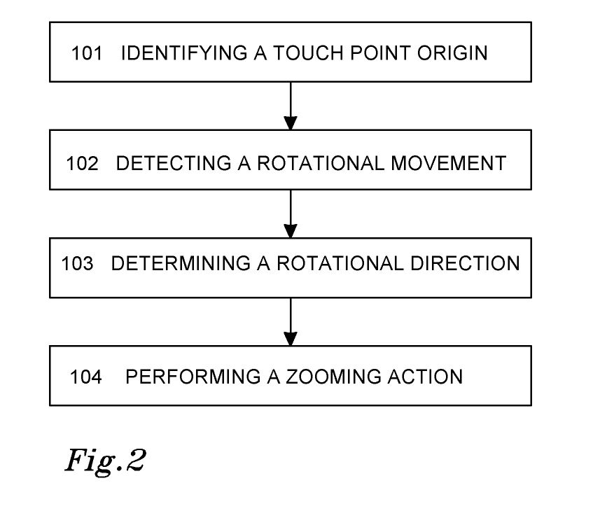

FIG. 2 is a flow chart showing a method in accordance with an embodiment. The method is preferably used with a display device 1 displaying a graphical image. The method comprises 101 identifying a touch point origin 3 in response to a user touching a touch sensitive display device 1 with a finger 2. Further, 102 detecting a rotational movement of the finger 2 in relation to the origin 3 is performed. The rotational movement is preferably performed while the tip of the finger 2 is still in contact with the touch point origin 3. The rotational direction of the rotational movement is determined 102. Thereafter, a zooming action associated with the rotational direction of the rotational movement is performed 103. To be able to detect the rotation of the finger 2 the touch display 1 may be supplemented with one or several sensors which can determine the location of the part of the finger 2 which are not in direct contact with the display 1. Such sensor may be one or several proximity sensors. Alternatively, the rotation of the finger 2 is detected by the touch sensor of the display 1.

Clockwise rotation of the finger 2 may for example be associated with a zooming in action, and counterclockwise rotation of the finger 2 may be associated with a zooming out action. The performed zooming in/out action may as well be performed vice versa.

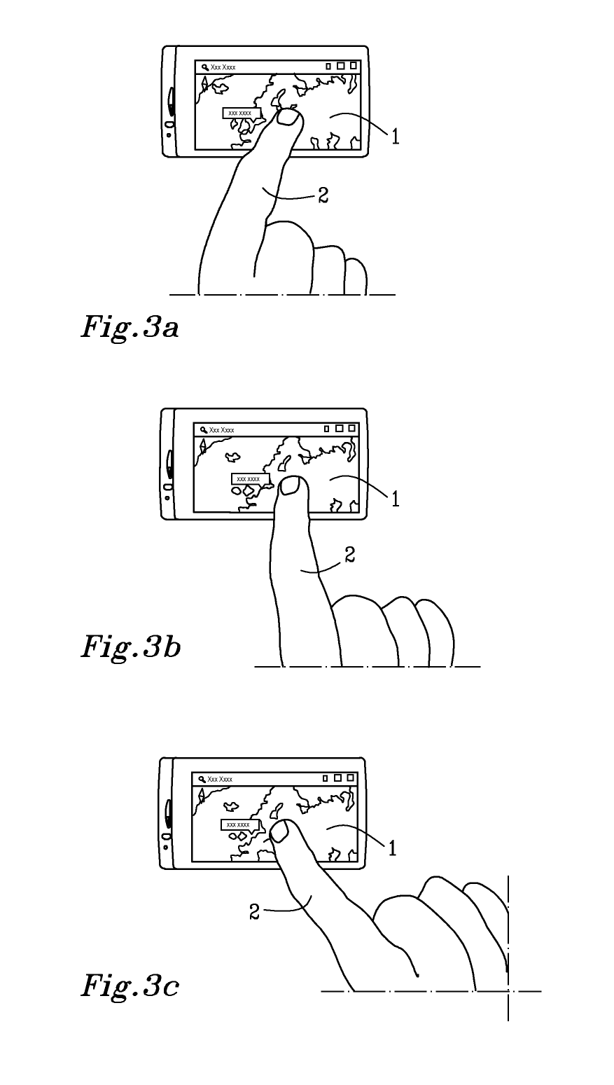

FIG. 3a-3c shows step by step the gesture for zooming performed by a user. In FIG. 3a, the user touches the touch display 1 with the top of the finger 2 at a touch point origin 3. In FIG. 3b, the user starts a rotational movement of the finger 2, while still in contact with the display 1, in a counterclockwise direction. In FIG. 3c, the rotational movement of the finger 2 is ended, and as a response a zooming action will be performed. During the whole zooming process, most of the surface of the display 1 is available to the user.

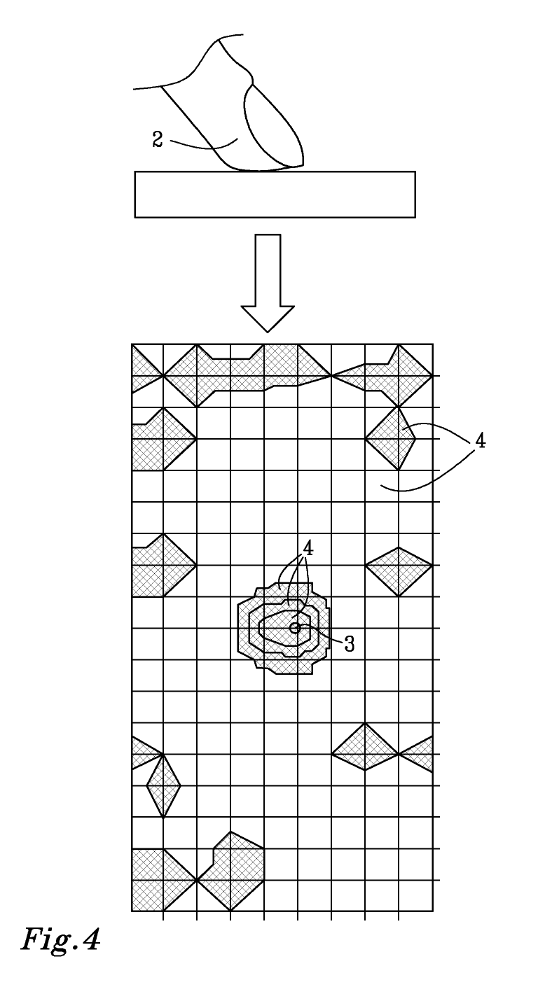

FIG. 4 shows an image of a touch sensor signal detecting a finger tip with touch point origin information and directional information. The touch sensor of the display 1 detects first the touch point origin 3 of the finger tip when touching the display 1. Thereafter, a rotational movement of the finger 2 is detected by the touch sensor. A compiled image showing the many measurements performed in each instant in a touch sensor is shown.

The detected signal strength in each point is represented by different zones 4. The combined shape of the signals under the finger 2 is oval meaning directional. This direction and how it changes over time can be interpreted by the touch sensor driver. Thereby both origin 3 and rotational direction is detected by the touch sensor driver and a zooming in or zooming out action can be performed accordingly.

The skilled person within the area realizes that the embodiments described above may be combined. Even different modifications are apparent to the skilled person. Thus is the invention not limited to the embodiments described. The invention is limited only by the in the claims defined scope of protection.

1. A method comprising:
identifying a touch point origin in response to a user touching a touch sensitive display device with a finger, the display device displaying a graphical image;
detecting a rotational movement of the finger in relation to the touch point origin;
determining a rotational direction of the rotational movement; and
performing a zooming action associated with the rotational direction of the rotational movement.

2. The method in accordance with claim 1, wherein the detecting of the rotational movement is performed responsive to the tip of the finger is remaining in contact with the touch point origin while rotating.

3. The method in accordance with claim 1, wherein determining a rotational direction of the rotational movement comprises determining whether the rotational movement is a clockwise rotation of the finger.

4. The method in accordance with claim 3, further comprising triggering a zoom-in action modifying the displayed graphical image based on determining that the rotation direction is clockwise.

5. The method in accordance with claim 1, wherein determining a rotational direction of the rotational movement comprises determining whether the rotational movement is a counterclockwise rotation of the finger.

6. A method in accordance with claim 5, further comprising triggering a zoom-out action modifying the displayed graphical image based on determining that the rotation direction is clockwise.

7. The method in accordance with claim 1 further comprising:
performing a panning action of the graphical image on the display device in response to the user performing a sliding movement of the finger from the touch point origin to another touch point, wherein direction and extent of the panning action is controlled based on the sliding movement of the finger.

8. The method in accordance with claim 7, wherein the panning action of the graphical image is performed concurrently with the zooming action based on detecting ongoing sliding movement of the finger concurrently with detecting ongoing rotational movement of the finger.

9. An apparatus, comprising:
a circuit configured for:
identifying a touch point origin in response to a user touching a touch sensitive display device with a finger, the display device displaying a graphical image;
detecting a rotational movement of the finger in relation to the touch point origin;
determining a rotational direction of the rotational movement; and
performing a zooming action associated with the rotational direction of the rotational movement.

10. The apparatus of claim 9, wherein the circuit configured for identifying a touch point origin comprises a touch sensor in the touch sensitive display device.

11. The apparatus of claim 9, wherein the means for detecting a rotational movement of the finger comprises a touch sensor comprised in the display.

12. The apparatus of claim 9, wherein the circuit configured for detecting a rotational movement of the finger comprises at least one proximity sensor.

13. The apparatus of claim 9, wherein the circuit configured for detecting a rotational movement of the finger comprises a plurality of proximity sensors.
